(19) United States
(12) Patent Application Publication
(10) Pub. No.: US 2011/0127263 A1
(43) Pub. Date: Jun. 2, 2011

(54) FIRE SAFETY APPARATUS OF HIGH-PRESSURE GAS FUEL TANK FOR VEHICLE

(75) Inventors: Hoonhui Lee, Seoul (KR); Hyungki Kim, Seoul (KR); Sanghyun Kim, Yongin (KR); Kiho Hwang, Yongin (KR)

(73) Assignees: HYUNDAI MOTOR COMPANY, Seoul (KR); KIA MOTORS CORPORATION, Seoul (KR)

(21) Appl. No.: 12/839,224

(22) Filed: Jul. 19, 2010

(30) Foreign Application Priority Data
Nov. 27, 2009 (KR) 10-2009-0115551

(51) Int. Cl. F17C 13/12

(52) U.S. Cl. 220/89.2

(57) ABSTRACT

The present invention relates to a fire safety apparatus for a high-pressure fuel tank of a vehicle, which can prevent a high-pressure fuel tank from exploding due to a fire and preferably preclude secondary damage due to high-pressure fuel tank, by forcibly discharging the high-pressure gas in high-pressure fuel tank, using a pressure operator, before high-pressure fuel tank is damaged and exploded by flame in a vehicle on fire.

### CROSS-REFERENCE TO RELATED APPLICATIONS

The present application claims under 35 U.S.C. §119(a) the benefit of Korean Patent Application Number 10-2009-0115551 filed Nov. 27, 2009, the entire contents of which application is incorporated herein for all purposes by this reference.

### BACKGROUND OF THE INVENTION

1. Field of the Invention

The present invention relates, generally, to a fire safety apparatus for a high-pressure gas fuel tank of a vehicle that forcibly discharges gas in the high-pressure fuel tank.

2. Description of Related Art

Compressed natural gas vehicles or hydrogen fuel cell vehicles are, for example as shown in FIG. 1, equipped with a high-pressure fuel tank 1 compressing and storing gas-state fuel at high pressure. Accordingly, a high-pressure fuel tank 1 should be able to suitably discharge the high-pressure gas therein by force, before it is damaged in a vehicle that is on fire.

For this purpose, a high-pressure fuel tank 1 is suitably equipped with a tank valve 3 to supply/discharge fuel and a tank valve 3 is suitably equipped with a pressure relief device 10.

Preferably, a pressure relief device 10 is, for example as shown in FIG. 2, suitably disposed between a tank connection channel 3a and an outside connection channel 3b of a tank valve 3, and suitably includes a piston 11, a spring 13, and a meltable metal 15 that is easily molten by heat.

Meltable metal 15 normally restrains the movement of piston 11 and is molten by heat when the temperature of a tank valve 3 reaches about 110°, and as meltable metal 15 is molten, a piston 11 is moved from the position shown in FIG. 2 to the left by the gas pressure inside a high-pressure fuel tank 1.

Accordingly, as a tank connection channel 3a and an outside connection channel 3b are suitably connected with each other, the gas in the high-pressure fuel tank 1 is rapidly discharged outside in the directions of arrows M1 and M2, and accordingly, it is possible to suitably prevent the high-pressure fuel tank 1 from exploding.

However, a pressure relief device 10 can normally operate and safely discharge the gas in a high-pressure fuel tank 1 only in a large fire in which the entire vehicle or the entire fuel system is suitably enveloped in flames, because it is installed only at a specific position (a tank valve or an end plug) of a high-pressure fuel tank 1.

Accordingly, heat transfer to a pressure relief device 10 is suitably delayed when only a portion of the high-pressure fuel tank 1 at a distance from the pressure relief device 10 is suitably exposed to a fire, such that high-pressure fuel tank 1 might be damaged and exploded, before the pressure relief device 10 operates.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

In one aspect, the present invention provides a fire safety apparatus for a high-pressure gas fuel tank of a vehicle that forcibly discharges the gas in the high-pressure fuel tank to the outside, before the high-pressure fuel tank is damaged and exploded in a vehicle that is on fire.

In a preferred embodiment, the present invention provides a fire safety apparatus for a high-pressure gas fuel tank of a vehicle which preferably includes a pressure operator suitably disposed around the high-pressure fuel tank and operating to connect/disconnect a tank connection channel with/from an outside connection channel in response to changes in pressure; and storage members suitably containing a heat reactive substances generating pressure while changing in phase by heat of a fire, and connected to the pressure operator around the high-pressure fuel tank.

According to further preferred embodiments of the present invention, it is possible to prevent a high-pressure fuel tank from exploding due to a fire and suitably preclude secondary damage due to the high-pressure fuel tank, by forcibly discharging the high-pressure gas in the high-pressure fuel tank, using a pressure operator, before the high-pressure fuel tank is suitably damaged and exploded by flame in a vehicle on fire.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a perspective view of a high-pressure fuel tank equipped with a pressure relief device according to certain preferred embodiments of the present invention.

FIG. 2 is a cross-sectional view showing the configuration of the pressure relief device according to other preferred embodiments of the present invention.

FIGS. 3 to 6 are views illustrating a fire safety apparatus for a high-pressure fuel tank using an intumescent according to preferred embodiments of the present invention.

FIG. 7 is a diagram of a heat reactive substance according to certain preferred embodiments of the present invention.

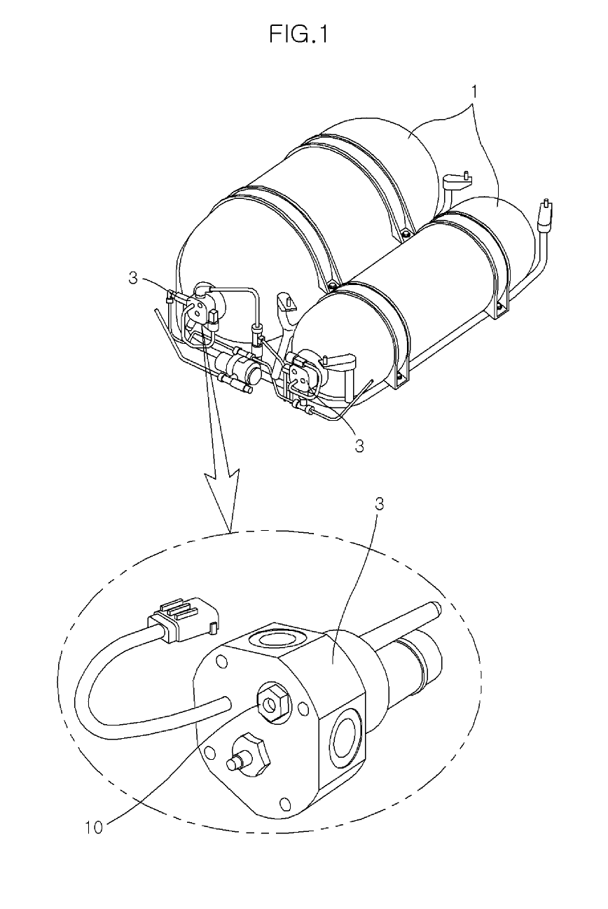

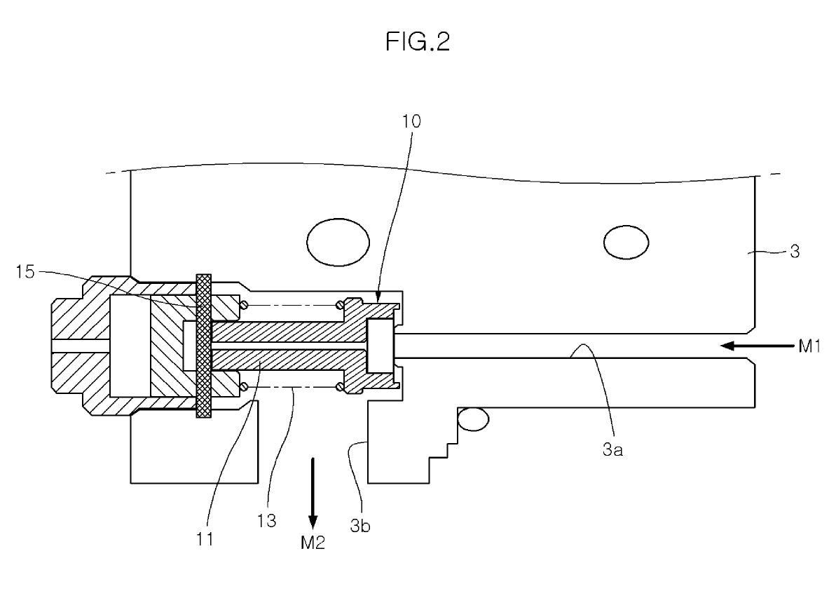

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, the present invention includes a fire safety apparatus for a high-pressure gas fuel tank of a vehicle, comprising a pressure operator, wherein the pressure operator is disposed around the high-pressure fuel tank, and storage members containing one or more heat reactive substances, wherein the storage members are connected to the pressure operator around the high-pressure fuel tank.

In one embodiment, the pressure operator operates to connect or disconnect a tank connection channel from an outside connection channel in response to changes in pressure.

In another embodiment, the one or more heat reactive substances generate pressure and change in phase as a result of the heat of a fire.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

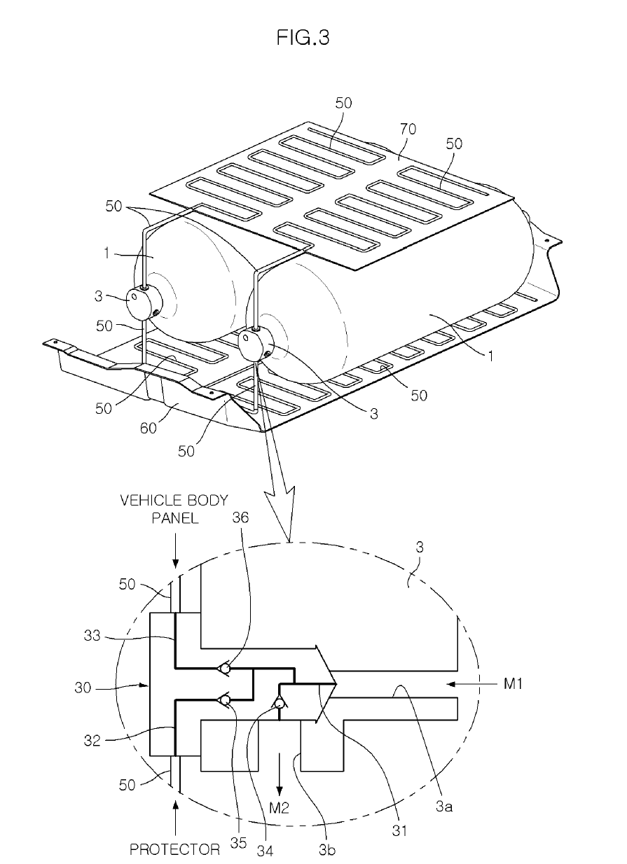

Compressed natural gas vehicles or hydrogen fuel cell vehicles are generally, as shown in FIG. 3, suitably equipped with a high-pressure fuel tank 1 compressing and storing gas-state fuel at high pressure, wherein a high-pressure fuel tank 1 is suitably equipped with a tank valve 3 for fuel supply and discharge, and a tank valve 3 is suitably equipped with a pressure operator 30 according to a preferred embodiment of the present invention.

According to certain preferred embodiments of the present invention, a pressure operator 30 operates to connect/disconnect a fuel connection channel 3a with/from an outside connection channel 3b of tank valve 3 in response to changes in pressure and various types of pneumatic valves or hydraulic valves can be used as pressure operators 30.

Preferably, pressure operators 30 according to certain embodiments of the present invention, are schematically shown for any one of the other types of operators and has a first channel 31 suitably connecting a tank connection channel 3a with the outside connection channel 3b, wherein a first channel 31 is suitably connected with a second channel 32 and a third channel 33 which are connected to the outside of pressure operator 30, and first, second, and third channels 31, 32, and 33 are suitably equipped with check valves 34, 35, and 36, respectively.

Preferably, in this configuration, it is possible to suitably increase or decrease the number of second and third channels 32 and 33 suitably connected to the outside of the pressure operator 30, if needed.

According to certain preferred embodiments of the present invention, second and third channels 32 and 33 are suitably connected with storage members 50 contained with a heat reactive substance 40. According to another further embodiment of the present invention, a second channel 32 is suitably connected with a storage member 50 provided for a protector 60 and third channel 33 is suitably connected with a storage member 50 provided or a vehicle body panel 70.

According to other further preferred embodiments, a pressure operator 30 may be suitably attached to an end plug of a high-pressure fuel tank 1, or may be attached to a vehicle body adjacent to high-pressure fuel tank 1 or a structure where storage members 50 are disposed.

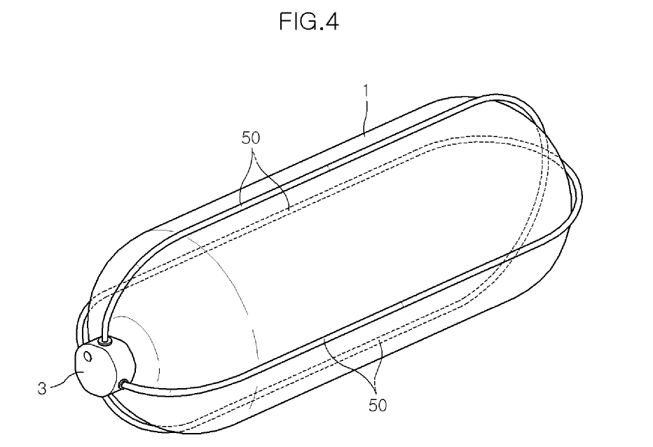

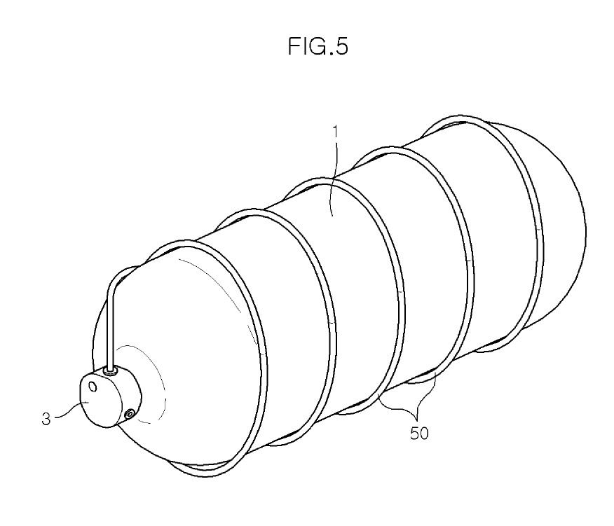

According to other further preferred embodiments, a storage member 50 is suitably formed of a tube or a pipe with high thermal resistance, and it may be in close contact with the surface of high-pressure fuel tank 1, for example as shown in FIG. 4, or may be wound around the surface of high-pressure fuel tank 1, for example as shown in FIG. 5.

According to still other further preferred embodiments of the present invention, the vehicle body is suitably equipped with a protector 60 to protect high-pressure fuel tank 1 from substances (stones, cans etc.) on the road while the vehicle is traveling. Preferably, when high-pressure fuel tank 1 is suitably disposed over a protector 60, storage members 50 are embedded at a predetermined distance in protector 60.

Further, according to other preferred embodiments, in order to take precautions against a fire inside vehicles, storage members 50 are also suitably embedded at a predetermined distance in the vehicle body where high-pressure fuel tank 1 is suitably disposed, or high-pressure fuel tank 1 is seated on the roof panel of buses, such that storage members 50 are embedded at a predetermined distance in the roof panel where high-pressure fuel tank 1 is suitably disposed.

In other further embodiments, when a vehicle body panel 70 is suitably disposed over high-pressure fuel tank 1, it is also possible to suitably embed storage members 50 in vehicle body panel 70 to reinforce the protective function of high-pressure fuel tank 1.

Preferably, storage members 50 contain a suitable heat reactive substance 40 that generates pressure while being changed in phase by heat of a fire, according to another preferred embodiment of the present invention.

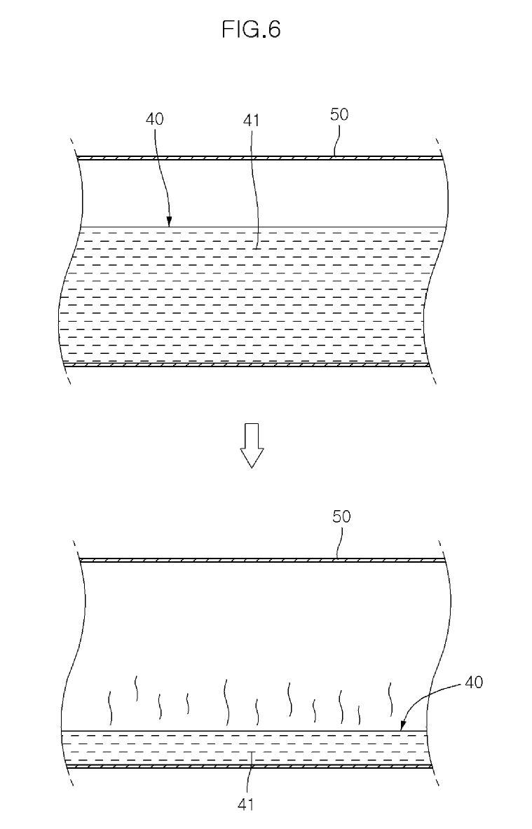

In other further preferred embodiments, a heat reactive substance 40 may be liquid 41 that is water or alcohol which suitably increases the internal pressure of storage members 50 while being evaporated by the heat of a fire, as shown in FIG. 6.

Preferably, although liquid 41 decreases in amount by evaporation due to the heat of a fire, a gas increases as much as the decrease in amount of the liquid, such that the internal pressure of storage members 50 can be suitably increased.

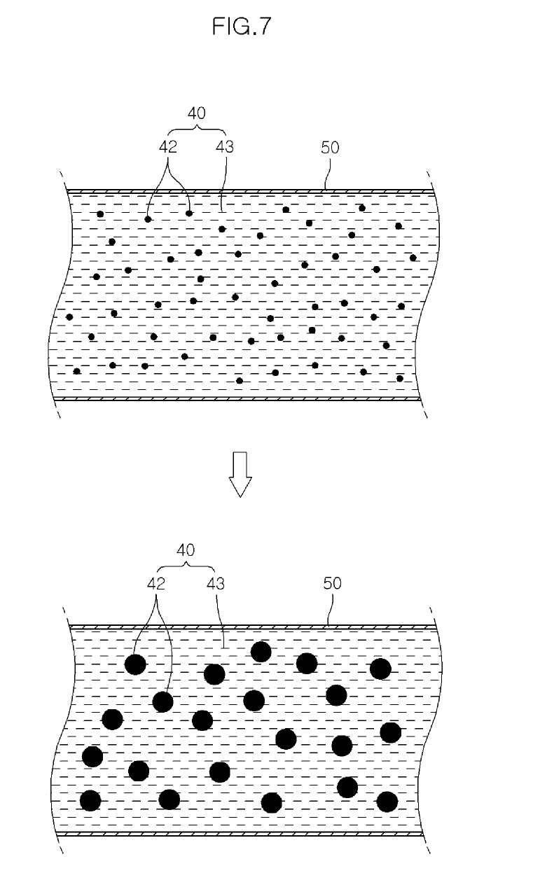

According to further preferred embodiments, a heat reactive substance 40 may be a solid compound 42 that suitably increases the internal pressure of storage members 50 while suitably increasing in volume by the heat of a fire, as shown in FIG. 7, and working fluid 43 is contained in storage members 50 for rapid heat exchange to pressure operator 30 in using solid compound 42.

Although the solid compound used in certain exemplary embodiments is polyethylene, it is not limited thereto, and working fluid 43 is oil filled in storage member 50, but it is also not limited thereto.

The operation of an exemplary embodiment of the present invention is described hereafter.

Preferably, a heat reactive substance 40 in storage members 50 suitably increases the pressure inside storage members 50 while changing in phase by the heat in a vehicle on fire.

Preferably, according to certain preferred embodiments, when the heat reactive substance 40 is liquid 41, such as water or alcohol, it increases the internal pressure of storage members 50 while being suitably evaporated by heat of a fire, or when the heat reactive substance 40 is a liquid compound 42, such as polyethylene, it suitably increases the internal pressure of storage members 50 while suitably increasing in volume by the heat of a fire.

Preferably, when a solid compound 42 is used as a heat reactive substance 40, it is required to fill up storage members 50 with working fluid 43 with oil to rapidly transmits pressure.

According to exemplary embodiments of the present invention, as the pressure inside storage members 50 is suitably increased by the heat in a fire, as described above, the increased pressure is suitably transmitted to the pressure operator 30 of a tank valve 3 and second and third channels 32 and 33 and a first channel 31 of a pressure operator 30, such that a check valve 34 blocking tank connection channel 3a and an outside connection channel 3b is opened.

According to other further preferred embodiments, as a check valve 34 opens, the high-pressure gas in a high-pressure fuel tank 1 is suitably discharged outside in the directions of arrows M1 and M2 of FIG. 3 through tank connection channel 3a and outside connection channels 3b, before the high-pressure tank 1 is damaged and explodes.

Therefore, according to preferred embodiments of the present invention, the high-pressure fuel tank 1 does not explode even if it is damaged and broken after discharging the high-pressure gas, such that it is possible to preclude secondary damage due to high-pressure fuel tank 1.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fire safety apparatus for a high-pressure gas fuel tank of a vehicle, comprising:
a pressure operator disposed around the high-pressure fuel tank and operating to connect/disconnect a tank connection channel with/from an outside connection channel in response to changes in pressure; and
storage members containing heat reactive substances generating pressure while changing in phase by heat of a fire, and connected to the pressure operator around the high-pressure fuel tank.

2. The fire safety apparatus for a high-pressure gas fuel tank of a vehicle as defined in claim 1, wherein the pressure operator is attached to a tank valve provided to the high-pressure fuel tank.

3. The fire safety apparatus for a high-pressure gas fuel tank of a vehicle as defined in claim 1, wherein the pressure operator is attached to an end plug of the high-pressure fuel tank.

4. The fire safety apparatus for a high-pressure gas fuel tank of a vehicle as defined in claim 1, wherein the pressure operator is attached to a vehicle body adjacent to the high-pressure fuel tank or a structure where the storage members are disposed.

5. The fire safety apparatus for a high-pressure gas fuel tank of a vehicle as defined in claim 1, wherein the heat reactive substance is liquid, such as water or alcohol, which increases the internal pressure of the storage members while being evaporated by the heat of a fire.

6. The fire safety apparatus for a high-pressure gas fuel tank of a vehicle as defined in claim 1, wherein the heat reactive substance is a solid compound that increases the internal pressure of the storage members while increasing in volume by the heat of a fire.

7. The fire safety apparatus for a high-pressure gas fuel tank of a vehicle as defined in claim 6, wherein the solid compound is polyethylene.

8. The fire safety apparatus for a high-pressure gas fuel tank of a vehicle as defined in claim 6, wherein the solid compound is contained in working fluid in the storage members.

9. The fire safety apparatus for a high-pressure gas fuel tank of a vehicle as defined in claim 8, wherein the working fluid is oil filled in the storage members.

10. The fire safety apparatus for a high-pressure gas fuel tank of a vehicle as defined in claim 1, wherein the storage members are tubes or pipes with high thermal resistance.

11. The fire safety apparatus for a high-pressure gas fuel tank of a vehicle as defined in claim 1, wherein the storage members are disposed in close contact with the surface of the high-pressure fuel tank.

12. The fire safety apparatus for a high-pressure gas fuel tank of a vehicle as defined in claim 1, wherein the storage members are wound around the surface of the high-pressure fuel tank.

13. The fire safety apparatus for a high-pressure gas fuel tank of a vehicle as defined in claim 1, wherein the storage members are embedded in a protector attached to a vehicle body to protect the high-pressure fuel tank.

14. The fire safety apparatus for a high-pressure gas fuel tank of a vehicle as defined in claim 1, wherein the storage members are embedded in the vehicle body or a roof panel where the high-pressure fuel tank is disposed.

15. A fire safety apparatus for a high-pressure gas fuel tank of a vehicle, comprising:
a pressure operator, wherein the pressure operator is disposed around the high-pressure fuel tank; and
storage members containing one or more heat reactive substances, wherein the storage members are connected to the pressure operator around the high-pressure fuel tank.

16. The fire safety apparatus for a high pressure gas fuel tank of a vehicle of claim 15, wherein the pressure operator connects or disconnects a tank connection channel from an outside connection channel in response to changes in pressure.

17. The fire safety apparatus for a high pressure gas fuel tank of a vehicle of claim 15, wherein the one or more heat reactive substances generates pressure or change in phase as a result of heat from a fire.
